(19) United States
(12) Patent Application Publication
(10) Pub. No.: US 2007/0169652 A1
(43) Pub. Date: Jul. 26, 2007

(54) Sleeve for a printing-press cylinder, and printing-press cylinder

(76) Inventors: Eduard Hoffmann, Bobingen (DE); Angelika Keck, Muenchen (DE); Christian Sameit, Augsburg (DE); Georg Schmid, Neusaess (DE)

Correspondence Address: CROWELL & MORING LLP;INTELLECTUAL PROPERTY GROUP, P.O. BOX 14300, WASHINGTON, DC, 20044-4300, US

(21) Appl. No.: 11/220,926

(22) Filed: Sep. 7, 2005

(30) Foreign Application Priority Data
Sep. 7, 2004 (DE) 10 2004 043 088.8

(51) Int. Cl. B41F 13/10

(52) U.S. Cl. 101/375

(57) ABSTRACT

A sleeve for a cylinder, in particular for a transfer cylinder or a blanket cylinder, of a printing press, having a base body which has at least one layer and a replaceable body which has at least one layer. The base body is connected fixedly to a cylinder of a printing press and the replaceable body can be pulled off, or replaced, from the base body, and thus, the cylinder of the printing press without being destroyed, in particular to carry out changeover work.

This application claims the priority of German Patent Document No. 10 2004 043 088.8, filed Sep. 7, 2004, the disclosure of which is expressly incorporated by reference herein.

### BACKGROUND AND SUMMARY OF THE INVENTION

The invention relates to a sleeve for a cylinder of a printing press. Furthermore, the invention relates to a cylinder of a printing press.

Sleeves favor quiet and jolt-free rolling of printing-press cylinders on one another as a consequence of the absence of the interruption of clamping channels which are otherwise usually present on the circumference of the cylinders.

German Patent Document DE 199 50 643A1 discloses a sleeve for a web-fed rotary printing press, which sleeve has a four-layer construction overall. The sleeve according to DE 199 50 643A1 has an inner layer which is configured as a carrier layer, namely a metal sleeve, and an outer layer which is configured as a covering layer and serves for print transfer, there being two further layers between the carrier layer and the covering layer. A compressible layer adjoins the inner carrier layer, and a layer made from a non-compressible material adjoins the outer covering layer. The compressible layer which adjoins the carrier layer and the layer which adjoins the covering layer and is made from non-compressible material are connected to one another.

In order to manufacture the sleeve according to DE 199 50 643A1, the procedure is that the remaining layers of the four-layer sleeve are applied to the metallic carrier sleeve in a multiplicity of individual steps one after another. The result of this is high manufacturing costs in total. If changeover work is to be carried out on a printing-press cylinder which is equipped with a sleeve of this type, the entire four-layer sleeve has to be removed from the printing-press cylinder. The removed sleeve has to be stored in appropriate devices. High storage costs result from the fact that the complete four-layer sleeve always has to be removed from the printing-press cylinder.

Proceeding from this, the present invention is based on the problem of providing a novel sleeve for a cylinder of a printing press, and a corresponding cylinder of a printing press.

According to the invention, a sleeve having a base body which has at least one layer and a replaceable body which has at least one layer is provided, the base body being connected to a cylinder of a printing press, and it being possible for the replaceable body to be pulled off, and thus replaced, from the base body and thus the cylinder of the printing press without being destroyed, in particular to carry out changeover work.

In the sleeve according to the invention, the base body remains permanently on the printing-press cylinder. Only the replaceable body, which is accordingly an independent assembly of the sleeve with respect to the base body, is pulled off from the printing-press cylinder or base body for changeover work. The base body which is connected to the printing-press cylinder is suitable for a multiplicity of different replaceable bodies. This results in firstly lower manufacturing costs and secondly lower storage costs.

The base body which is connected to the cylinder of the printing press preferably has a two-layer construction comprising a sleeve and a layer which is applied on the outside of a surface of the sleeve and is preferably compressible. The replaceable body likewise preferably has a two-layer construction comprising an outer layer which serves for print transfer and a register layer which adjoins the outer layer on the inside.

### BRIEF DESCRIPTION OF THE DRAWINGS

Preferred developments of the invention result from the following description. Without being restricted thereto, exemplary embodiments of the invention will be explained in greater detail using the drawings as described below.

FIG. 1 shows a detail of a cross-section through a cylinder of a printing press together with a base body of a sleeve in the context of the present invention.

FIG. 2 shows a detail of a cross-section through a replaceable body of a sleeve in the context of the present invention.

FIG. 3 shows a detail of a cross-section through a cylinder of a printing press together with a base body and a replaceable body of a sleeve in the context of the present invention.

### DETAILED DESCRIPTION OF THE DRAWINGS

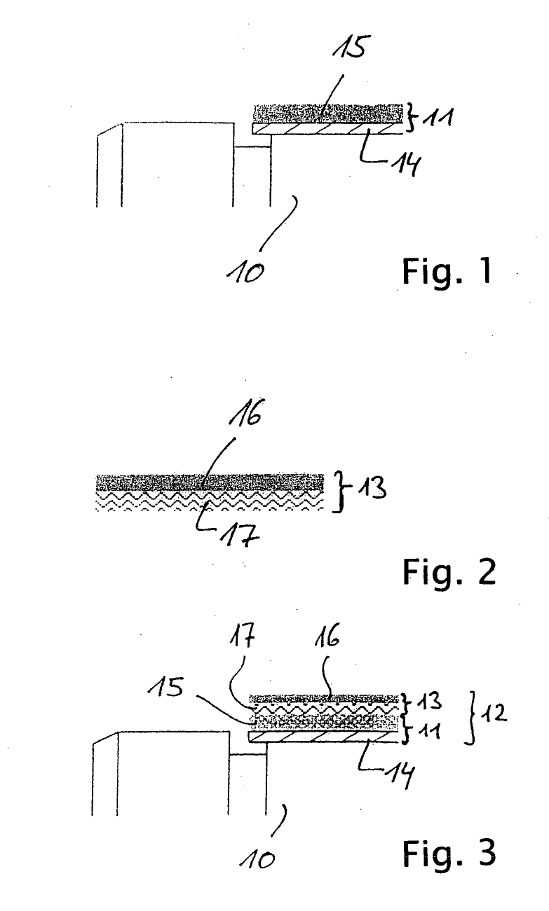

In the following text, the present invention will be described in greater detail with reference to FIGS. 1 to 3.

FIG. 1 shows a detail of a cylinder 10 of a printing press, namely of a transfer cylinder or blanket cylinder. A base body 11 of a sleeve which is designated overall by the reference numeral 12 adjoins a surface of the cylinder 10 radially on the outside. Furthermore, in addition to the base body 11, the sleeve 12 has a replaceable body or exchangeable body 13 (see FIG. 2), FIG. 3 showing a sleeve 12, together with the cylinder 10, which sleeve 12 is composed of the base body 11 and the replaceable body 13.

Within the context of the present invention, a sleeve 12 for a cylinder 10 of a printing press is provided, which sleeve 12 is composed of a base body 11 and a replaceable body 13. The base body 11 is connected to the cylinder 10 of a printing press permanently, fixedly and preferably non-releasably. A base body 11 which is connected non-releasably to the cylinder 10 can be removed from the cylinder 10 only by being destroyed. The replaceable body 13 is configured as an independent assembly of the sleeve 12 and can be pushed onto a base body 11 and pulled off from the base body 11 without being destroyed. Accordingly, for changeover work, the replaceable body 13 merely has to be pulled off from the base body 11 or from the cylinder 10 of the printing press and fed to a storage means. It should be pointed out that the base body 11 can also be connected releasably to the cylinder 10 and can thus be pulled off from the latter without being destroyed.

In the exemplary embodiment of FIGS. 1 to 3, the base body 11 has a two-layer construction. The base body 11 thus has a sleeve 14 and a layer 15 which adjoins the sleeve 14 on the outside. The sleeve 14 is preferably configured as a metallic sleeve made from stainless steel. The layer 15 is preferably a compressible layer made from a rubber material. The layer 15 forms, as it were, a frictional-fit layer for the replaceable body 13, which frictional-fit layer brings about adhesion of the replaceable body 13 on the base body 11.

Although a two-layer base body is shown in FIGS. 1 to 3, it is to be pointed out at this juncture that it goes without saying that a single-layer base body can also be used. A single-layer base body of this type is then formed only by a sleeve which is preferably roughened on its surface for example by sandblasting and again forms a frictional-fit layer for the replaceable body. The sleeve or base body can also be profiled on its surface and form a form-fitting layer for the replaceable body. A base body which has more than two layers is also conceivable.

In the exemplary embodiment shown, the replaceable body 13 also has a two-layer construction, namely comprising an outer layer 16 which serves for print transfer and a register layer 17 which adjoins the outer layer 16 on the inside. The outer layer 16 which serves for print transfer can be of compressible or non-compressible configuration. The register layer 17 can likewise be of compressible or non-compressible configuration and is preferably formed from a woven fabric or a plastic or a synthetic resin or a synthetic resin/woven fabric composite, in order to provide the required strength or rigidity. The replaceable body 13 can be manufactured to be seamless or have a butt joint or butt seam. As has already been mentioned, the replaceable body 13 can be pulled off from the base body 11 and thus from the cylinder 10 of the printing press without being destroyed. The base body 11 is connected fixedly or permanently to the cylinder 10.

Although a two-layer replaceable body is illustrated in the exemplary embodiment shown, it is to be pointed out that a replaceable body having only one layer or a replaceable body having more than two layers can also be used. In a replaceable body having only one layer, the outer layer which serves for print transfer is then present, which can be pushed onto a base body and pulled off from the latter.

Accordingly, it lies within the scope of the present invention to provide a sleeve which comprises two assemblies which are separate from one another, namely a base body and a replaceable body. The base body is connected permanently to a printing-press cylinder. The replaceable body can be pushed onto the base body and pulled off from the latter. In order to carry out changeover work on the cylinder of a printing press, the replaceable body is merely pulled off from the base body and thus the cylinder and fed to a storage means. As a result, firstly the manufacturing costs for sleeves and secondly the storage costs for the latter are reduced.

### LIST OF REFERENCE NUMERALS:

10 Cylinder
11 Base body
12 Sleeve
13 Replaceable body
14 Sleeve
15 Layer
16 Outer Layer
17 Register layer

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A sleeve for a cylinder, in particular for a transfer cylinder or a blanket cylinder, of a printing press, having a base body which has at least one layer and a replaceable body which has at least one layer, wherein the base body is connected to the cylinder of the printing press and wherein the replaceable body is removably attachable to the base body, and thus the cylinder of the printing press, without being destroyed, in particular to carry out changeover work.

2. The sleeve according to claim 1, wherein the base body which is connected to the cylinder of the printing press has a single-layer construction comprising a sleeve.

3. The sleeve according to claim 2, wherein a surface of the base body is roughened and forms a frictional-fit layer for the replaceable body.

4. The sleeve according to claim 2, wherein a surface of the base body is profiled and forms a form-fitting layer for the replaceable body.

5. The sleeve according to claim 1, wherein the base body which is connected to the cylinder of the printing press has a two-layer construction comprising a sleeve and a layer which is applied on an outside of a surface of the sleeve.

6. The sleeve according to claim 5, wherein the layer which is applied on the outside of the surface of the sleeve is a compressible layer and forms a frictional-fit layer for the replaceable body.

7. The sleeve according to claim 5, wherein the layer which is applied on the outside of the surface of the sleeve is a rubber layer and forms a frictional-fit layer for the replaceable body.

8. The sleeve according to claim 1, wherein the base body is connected non-releasably to the cylinder of the printing press.

9. The sleeve according to claim 1, wherein the base body is connected releasably to the cylinder of the printing press.

10. The sleeve according to claim 1, wherein the replaceable body has a single-layer construction comprising an outer layer which serves for print transfer.

11. The sleeve according to claim 1, wherein the replaceable body has a two-layer construction comprising an outer layer which serves for print transfer and a register layer which adjoins the outer layer at an inside surface of the outer layer.

12. The sleeve according to claim 10, wherein the outer layer is of a compressible configuration.

13. The sleeve according to claim 11, wherein the outer layer is of a compressible configuration.

14. The sleeve according to claim 10, wherein the outer layer is of a non-compressible configuration.

15. The sleeve according to claim 11, wherein the outer layer is of a non-compressible configuration.

16. The sleeve according to claim 11, wherein the register layer is formed from a woven fabric or a plastic or a synthetic resin or a material composite.

17. The sleeve according to claim 11, wherein the register layer is of a compressible or a non-compressible configuration.

18. A cylinder, in particular a transfer cylinder or a blanket cylinder, of a printing press, having a sleeve, wherein the sleeve is formed from a base body which has at least one layer and a replaceable body which has at least one layer, wherein the base body is connected to the cylinder of the printing press and wherein the replaceable body is removably attachable to the base body, and thus the cylinder of the printing press, without being destroyed, in particular to carry out changeover work.

19. A cylinder, in particular a transfer cylinder or a blanket cylinder, of a printing press, having a base body of a sleeve, wherein the base body is connected to the cylinder and has at least one layer and provides a frictional-fit layer to hold a replaceable body of the sleeve, wherein the replaceable body comprises an outer layer which serves for print transfer.

20. A sleeve for a cylinder of a printing press, comprising:
a base body; and
a replaceable body, wherein the replaceable body is removably attached to the base body in an operable configuration of the sleeve.

21. A sleeve for a cylinder of a printing press, comprising:
a base body;
a replaceable body; and
means for removably attaching the replaceable body to the base body in an operable configuration of the sleeve.

22. A printing press, comprising:
a cylinder;
a base body connected to the cylinder; and
a replaceable body, wherein the replaceable body is removably attached to the base body.

23. The printing press according to claim 22, wherein the base body is fixedly connected to the cylinder.

24. A method for attaching a sleeve to a cylinder of a printing press, comprising the steps of:
connecting a base body of the sleeve to the cylinder; and
removably attaching a replaceable body to the base body.

25. The method according to claim 24, further comprising the step of fixedly connecting the base body to the cylinder.

26. The method according to claim 24, further comprising the steps of:
removing the replaceable body from the base body; and
removably attaching a second replaceable body to the base body.
